(19) United States
(12) Patent Application Publication
(10) Pub. No.: US 2014/0280622 A1
(43) Pub. Date: Sep. 18, 2014

(54) SYSTEM AND METHOD FOR COLLECTING AND EXCHANGING DATA

(71) Applicant: Frank Philipp Albert, Graz (AT)

(72) Inventor: Frank Philipp Albert, Graz (AT)

(73) Assignee: 2stic GmbH, Graz (AT)

(21) Appl. No.: 13/834,200

(22) Filed: Mar. 15, 2013

(51) Int. Cl. H04L 12/58

(52) U.S. Cl. CPC H04L 51/32
USPC 709/206; 709/204

(57) ABSTRACT

A system, method and computer-readable medium having instructions stored thereon for performing the methods of the present invention are provided. Embodiments of the present invention include a platform (also referred to as “forum”) for selling, purchasing, collecting, viewing, and exchanging data, e.g., pics, videos, other digital mediums, etc. online. A user can maintain collection of pics, for example, similar to a physical card collection or a sticker album of a sporting team, movie, and entertainer, exclusively in an online platform. The user can collect, exchange, and interact with other users having a similar collection. Interaction with other users can include, for example, displaying the user's collection via an electronic and/or online album, competing with another user over completing a collection such as a limited electronic card/pic/video, and exchanging cards/pics/videos with another user.

### COPYRIGHT AND LEGAL NOTICES

A portion of the disclosure of this patent document may contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates generally to a collecting and exchanging forum in which a user can purchase, collect, view, and exchange data. More specifically, a user can have a collection of pics, for example, similar to a physical card collection or a sticker album of a sporting team, movie, and/or entertainer. The user can collect, exchange, and interact with other users having a similar collection. The user can organize and display the collection via an electronic album.

### SUMMARY OF THE INVENTION

Embodiments of the present invention include a platform (also referred to as “forum”) for selling, purchasing, collecting, viewing, and exchanging data, e.g., pics, online A user can maintain collection of pics, for example, similar to a card collection or a sticker album of a sporting team, movie, and entertainer, exclusively in an online platform. The user can collect, exchange, and interact with other users having a similar collection. Interaction with other users can include, for example, displaying the user's collection via an electronic and/or online album, competing with another user over completing a collection such as a limited electronic card/pic, and exchanging cards/pics with another user. Beyond collecting the physical pic itself, an embodiment of the present application can include videos, sounds, and additional content as and/or alongside the pics.

The present invention provides a system and method for collecting one or more digital images by a first user, including: the first user receiving the one or more digital images; and locating the one or more digital images in an inbox of the first user, wherein the one or more digital images are connected to a common theme. In embodiments of the present invention, the receiving of the one or more digital images is purchasing a group of one or more digital images. In embodiments of the present invention, the receiving of the one or more digital images is receiving a free digital image. In embodiments of the present invention, the one or more digital images is one or more pics. In embodiments of the present invention, the group of the one or more digital images is a pack. In embodiments of the present invention, the pack is distributed in subgroups over a predefined time period. In embodiments of the present invention, the free digital image is a freebie pic. Embodiments of the present invention include pasting a digital image from the one or more digital images into a collection.

The present invention provides a system and method for collecting one or more digital images by a first user, including an email inbox account accessed via a processor which receives and stores the one or more digital images, a display screen for viewing the one or more stored digital images, a processor for running an electronic digital images album, wherein the one or more stored digital images can be transferred from the email inbox to the electronic digital images album and placed in one of various predetermined locations.

A computer-readable medium having instructions stored thereon which, when executed by a processor or other appropriate device, perform the method embodiments described throughout this Specification.

Embodiments of the present invention include selecting a digital image from the one or more digital images to create and send a trade proposal to send a trade proposal to a second user. Embodiments of the present invention include accepting by the second user the trade proposal of the first user, wherein the second user selects an other digital image from an inbox of the second user to create and send a further trade proposal to the first user.

The present invention provides a system and method for hanging a digital image from the one or more digital images, including: moving the digital image from the inbox of the first user to an inbox of a second user; and moving the other digital image from the inbox of the second user to the inbox of the first user.

The present invention provides a system and method for collecting and exchanging a digital image between a first user and a second user, including: the first user receiving the digital image; locating the digital image in an inbox of the first user; selecting the digital image by the first user to create and send a trade proposal to the second user; the second user accepting the trade proposal of the first user, wherein the second user selects an other digital image to create and send a further trade proposal; and the first user accepting the further trade proposal to trade the digital image for the other digital image; wherein the digital image is exchanged for the other digital image in the inbox of the first user. In embodiments of the present invention, the digital image is at least one of: animated, animation, and a video. In embodiments of the present invention, one or more digital images are collected in a collection. The collection can be subdivided into pages. In embodiments of the present invention, one or more pics are grouped together in a pic set for a particular purpose. In embodiments of the present invention, the one or more pics are optically arranged in the pic set. In embodiments of the present invention, the pic set unlocks a new feature. In embodiments of the present invention, the feature is an achievement, the achievement being displayed to the first user by at least one of: text, picture, and addition of at least one point to a point balance associated with the first user.

The present invention provides a system and method for collecting and exchanging a digital image between a first user and a second user, including: the first user requesting the digital image; locating the digital image in an inbox of the second user; creating and sending a trade request to the second user; the second user accepting the trade request of the first user, wherein the second user selects an other digital image to create and send a trade proposal to the first user; and the first user accepting the trade proposal to trade the other digital image for the digital image; wherein the other digital image is exchanged for the digital image in the inbox of the second user.

The present invention provides a system and method for acquiring an exchange partner by a first user, including: determining that the first user has not reached a selectable maximum number of exchange partners; responsive to the determination, the first user inviting a second user to become the exchange partner of the first user; the second user accepting the exchange partner request; and enabling trading between the first user and the second user.

The present invention provides a system and method for collecting and exchanging a digital image between a first user and an exchange partner, including: displaying a list of exchange partners who are in geographic proximity to the first user; the first user selecting an exchange partner for trading; the exchange partner accepting the request for trading; the first user selecting the digital image from an inbox of the first user; the exchange partner selecting an other digital image from an inbox of the exchange partner; and creating and sending a trade proposal with the digital image and the other digital image to the first user and the exchange partner; the first user accepting the trade proposal to trade the digital image for the other digital image; and the exchange partner accepting the trade proposal to trade the digital image for the other digital image, wherein the digital image is exchanged for the other digital image in the inbox of the first user.

### BRIEF DESCRIPTION OF THE DRAWINGS

FIG. 1A shows an example pic according to an embodiment of the present invention.

FIG. 1B shows an example pic according to an embodiment of the present invention.

FIG. 1C shows an example pic according to an embodiment of the present invention.

FIG. 1D shows an example pic according to an embodiment of the present invention.

FIG. 1E shows an example pic according to an embodiment of the present invention.

FIG. 2A shows an example pic set according to an embodiment of the present invention.

FIG. 2B shows an example pic set according to an embodiment of the present invention.

FIG. 2C shows an example pic set according to an embodiment of the present invention.

FIG. 2D shows an example pic set according to an embodiment of the present invention.

FIG. 3A shows an example GUI in a first step for a making and completing an exchange according to an embodiment of the present invention.

FIG. 3B shows an example GUI in a second step for a making and completing an exchange according to an embodiment of the present invention.

FIG. 3C shows an example GUI in a third step for a making and completing an exchange according to an embodiment of the present invention.

FIG. 4 shows an example normal view according to an embodiment of the present invention.

FIG. 5 shows an example inbox and compact view to paste pics according to an embodiment of the present invention.

FIG. 6 is a flowchart showing an example method for requesting and becoming exchange partners according to an embodiment of the present invention.

FIG. 7 is a flowchart showing an example method for making and completing a trade proposal according to an embodiment of the present invention.

FIG. 8 is a flowchart showing an example method for making and completing a trade request according to an embodiment of the present invention.

FIG. 9 is a flowchart showing an example method for purchasing a pack according to an embodiment of the present invention.

FIG. 10 is a flowchart showing an example method for making and completing an exchange on a mobile device according to an embodiment of the present invention.

### DETAILED DESCRIPTION

A user is a person using a platform as embodied in the present application. A registered user is a user who has registered on the platform with identifying data, for example, a username, password, and/or an e-mail address. The term “user” will refer to registered users unless specified otherwise.

FIGS. 1A to 1E show various embodiments of pics. A pic is a digital image decal that can be displayed in a predefined location within a collection. Pics can be purchased. Pics can also be free to a user, for example, as a gift and/or incentive. Pics can be traded with other users. In embodiments, a user registers on the platform to trade pics and/or purchase additional pics. Pics can be the same size within a specified collection. Pics can also be different sizes. Pics can be still images, animated images, video, sounds, songs etc. Pics can be displayed horizontally or vertically (e.g., portrait or landscape). A pic in a specified collection can have a distinct and immutable alphanumeric identification number. The identification number of a pic within a specified collection can be continuous in number to other pics within the same collection. When a specified collection is created, one or more pics are numbered automatically. Pics can be added to a specified collection after the specified collection is released. If pics are later added to a specified collection, the existing numbering can remain unaffected. The later pics can be introduced with a new range of numbers.

Users can compete over the completion of their respective collections. In embodiments, the platform can interface with third-party social media sites such as FACEBOOK, TWITTER, and GOOGLE+ to enable users to keep friends and followers informed about the progress of their respective collections. In embodiments, the progress of the collection can be marked by partial or total completion of optical- and logical-groupings of pics as further described below. For example, when a user has completed half of a collection, the achievement can be displayed in third-party social media sites.

Pics can be labeled, for example, as shown in FIGS. 1A to 1C with identifying information. The newest pics can be indicated with a label as “new” when first displayed, as shown in FIG. 1A. For example, the pic(s) may have been received within the last few days, or may have been traded while the user was not actively logged into the platform. If an exchange partner (defined herein) makes a trade request or trade proposal regarding a pic, this may be indicated on the pic as shown in FIG. 1C. In an embodiment, trade requests or trade proposals can be shown in the “shop window” menu as further discussed below.

In embodiments where there are more than one of the same pic in an inbox, defined herein, all of the duplicates are grouped into one single pic pile in the display, to which an icon is added, indicating the number of pics within the pile, as shown in FIG. 1B. For example, in FIG. 1B, there are three pics are in the pile and is denoted by an icon “3” in the bottom right corner. The icon can be placed anywhere on the pic or near the pic, and can be represented by text or graphics. A graphical icon example is shown in FIG. 1D. Another example embodiment of duplicate pics is shown in FIG. 1E. When a pic pile is moved, the whole pile is moved. The pile can be the pics stacked on top of each other such that they at least partially overlap.

A collection is a grouping of all pics concerning a particular topic. The collection can be related to any number of topics, including, but not limited to, a sporting team, movie, and entertainer. For example, a user can begin a collection called Borussia Dortmund Soccer Collection 2012/2013, which includes individual pics relating to the Borussia Dortmund Soccer Team 2012/2013. A collection can also include additional content to be displayed on the user's collection page. The additional content can be static, dynamic, and/or a combination of both (also referred to as “bonus content”). For example, static content may be still pictures. For example, dynamic content may be animated images and/or videos. For example, a combination of both may be both still pictures intermixed with animated images and/or videos and/or feed from a remote source (e.g., RSS, Twitter-feed, YouTube, etc.)

In an embodiment, a user can begin a collection by collecting pics to display in their collection. A user starting a new collection can receive one or more free pics to be immediately included, or pasted, in their collection (described below). The number of free pics corresponding to the start-up of a new collection can be predefined. A user can collect and manage one or more collections. In an embodiment, if a user collects and manages more than one collection, the collections are independent in the sense that they are not merged. In an embodiment, a user must first register in order to manage a collection. A new user can begin a collection without registering, if registration occurs within a set time period. The set time period can be, for example, 48 hours.

In an embodiment, a collection can include one or more pages. A large collection can result in creating additional pages. For example, a large collection is one containing 351 to 750 pics, a medium collection is one containing 101 to 350 pics, and a small collection contains 30 to 100 pics. The average collection size varies based on the theme. A page can be viewed individually by a user. A page can be created without including specific content, including pictures. A page created without content can contain sections to improve user navigation, for example, by reducing loading time. For example, the Borussia Dortmund Soccer Collection 2012/2013 can include a file entitled, for example, Borussia Dortmund>Club/Team/Table. Further files can be nested within an electronic album or page (e.g., webpage). A page of an electronic album can include one or more sections. To simplify content structure on a page, it can be divided into separate content areas. For example, the Borussia Dortmund Soccer Collection 2012/2013 collection can include Borussia Dortmund>Team>Goal/Defense/Midfield/Offense. For example, separate content areas can include, but are not limited to, sections, graphic elements, background, and/or color. In an embodiment, a user accessing the platform via a mobile smartphone application (also referred to as an “app”) can view the sections as pages to limit a length of a single page. A section can include one or more content elements. A content element can include, but is not limited to, pictures, texts, videos, audio content, line dividers, and buttons. A collection can include content elements that are graphically arranged. In an embodiment, pages and section are predefined by the platform, and user actions trigger content and/or bonus content by fulfilling conditions such as collecting all the pics on a single page. In an embodiment, a user can navigate within a collection with a navigation menu. The navigation menu can include pages and sections of the collection. In an embodiment, the navigation menu includes additional control elements to enable the direct purchase of items in a collection. In an embodiment, information is displayed in the navigation menu, for example the page number of the collection, account balance, and percentage of completion of the collection.

FIGS. 2A and 2B show example data sets, e.g., pic sets. A pic set is defined to be one or more pics within a specified collection grouped together for a particular purpose. FIG. 2A shows an exemplary optically-grouped pic. An optically grouped pic is one in which multiple pics form a larger image. For example, a player portrait comprises multiple pics, where each pic shows a partial image of the player portrait. Individual pics 205, 210, 215, and 220 each show a portion of a whole image, to form pic set 225. Both an optically grouped pic and a logically grouped pic (“grouped pic” refers to both optically grouped pics and logically grouped pics for convenience) can unlock one or more features. For example, a grouped pic can unlock a video, bonus features such as additional images and information, and a free-form pic. A free-form pic is one in which, an image comprising one or more pics can be displayed as a background picture. In an embodiment, the image is displayed in grayscale until all pics comprising the image is pasted. In another embodiment, the image does not have full color saturation until all pics comprising the image is pasted. In another embodiment, the image is displayed with reduced brightness until all pics comprising the image is pasted. When all the pics are pasted, the image is then displayed in full color saturation, and any border lines between the pics can disappear to form the full image.

In embodiments, an optically grouped pic differs from a logically grouped pic in that it is possible to play a video directly in the optically grouped pic. For example, referring to FIG. 2A, once all the individual pics 205, 210, 215, and 220 are pasted, a whole image is formed. The whole image corresponds to a first frame of a video. A play icon is then displayed overlaid on the image, which a user can select to activate playing of the video. In a further embodiment, the logically grouped pic allows for video to be played. FIG. 2C shows an example of an optically grouped pic, where five pics have been placed and one pic of the group is missing, i.e., next to achieve if the user is interested in completing the group. A grayed video play symbol is shown on the grouped pic, indicating that upon completion of the group, a video may be unlocked and/or made available to the user.

FIG. 2B shows an example embodiment of a logically-grouped pic set. A logically-grouped pic is one in which one or more pics or pic sets are pasted (described below), and a certain feature within the specified collection is unlocked. FIG. 2B shows an embodiment of a logically grouped pic set. Individual pic 230 can show image A1, pic 235 can show image A2, and pic 240 can show image A3, each a different image. When pics 230, 235, and 240 are pasted into a specified collection, together they unlock a certain feature. A certain feature can include, but is not limited to extra content, video files, a free-form pic and additional pics. In another embodiment, one or more pics will be changed into an image with a different form than the pasted pic(s). FIG. 2D shows an example of a logically-grouped pic set. This logically-grouped pic set refers to a chassis of a vehicle. The various pics of this group can be, for example, parts of a chassis and/or use for same. Information regarding a chassis is provided on the page. Further information regarding a chassis may be unlocked and displayed on the page or elsewhere as a user places pics in the grouped pic set. A grayed video play symbol is shown on a separate location without a number, indicating that, for example, upon completion of the logically-grouped set, a video or other transmission or digital file may be unlocked and/or made available to the user.

In an embodiment, the user can unlock achievements with his collection efforts. An achievement is defined by the platform. In an embodiment, the criteria for an achievement are known to the user. In another embodiment, the criteria for an achievement are not known to the user. For example, a user reaches the achievement of “Halftime,” when he obtains 50% of the Borussia Dortmund collection. In an embodiment, an achievement can be displayed as text describing the achievement, a picture, and/or a point value. In an embodiment, achievements can be tracked across all users. For example, there can be a single achievement awarded to the first of all users who completes a particular collection. There can also be a limited number of achievements for all users. For example, only 49 “runner-up” achievements for the 49 users who complete a particular collection after the collection was completed for the first time by a user. In an embodiment, achievements can be tracked for a single user. For example, these achievements can be reached by every single user fulfilling the criteria of the achievement. In an embodiment, achievements are for single collections. In an embodiment, achievements are global and capture the efforts of the user over all of his or her collections. For example, the user can receive an achievement for collecting 1,000 unique pics. In an embodiment, achievements are linked to prizes or the possibility to win a prize.

Competitive spirit among users can also be fostered by a point system. In an embodiment, a user can collect points on the platform for reaching achievements. In an embodiment, a user can collect points for making certain purchases such as large purchases or for other actions. The points can increase his rank among other users. In an embodiment, a user is assigned to a particular status level corresponding to the number of points accumulated (for example, Bronze, Silver, Gold, Platinum, and/or Diamond).

In an embodiment, the number of pics to complete a pic set can be a specified number of pics horizontally and a number of pics vertically, creating, for example, a matrix of pics. Generally, a maximum pic set is 6×6 pics. Any combination number of pics horizontally and vertically can create a pic set. Pic sets larger than 6×6 can also be created. In an embodiment, the size and the dimensions of a pic set is preset.

A freebie pic is a pic that a user receives for free. For example, a user can receive a freebie pic during marketing and/or bonus campaigns (or during other events and/or opportunities). In an embodiment, a user receives a freebie pic as an incentive. An incentive, for example, is a freebie pic that can be distributed to a user when an element on the platform is activated and/or transferred and/or fulfilled. For example, a user receives an incentive for: confirming his or her e-mail address, entering additional personal data, and trading pics. In an embodiment, the user is notified directly on the platform of the receipt of an incentive and the quantity of freebie pics available. In an embodiment, a user activating and/or transferring and/or fulfilling an element on the platform can receive one or more freebie pics in their inbox.

In an embodiment, the freebie pic can be added directly to a user's inbox without changing the user's account balance. The user can receive a notification that the freebie pic is added to their inbox. A freebie pic can also be a collision. A collision is a duplicate pic to a pic the user already has in their collection. Collisions may encourage trading via the platform by encouraging and/or permitting a user to trade and/or transfer the duplicate pic to another via the platform and/or internet and/or local area network (LAN).

A pack (also referred to as a “pic pack”) is a specified number of pics a user can purchase via the platform to add to their collection. The specified number of pics in each pack is predefined. The number of pics in each pack can be different for any specified collection. For example, a Borussia Dortmund collection can have packs containing five pics each. More than one pack can be purchased at a time. A user can receive one or more identical (e.g., duplicate) pics within a pack. A user can receive a collision.

A freebie pack is a specified number of pics a user receives for free. A user can receive a freebie pack during marketing and/or bonus campaigns. Similar to a freebie pic, a user can receive a freebie pack as an award and/or bonus, a reward for activities, and/or achievements by the user on the platform. Embodiments of freebie packs are not added directly to the user's inbox, but added to the user's account balance. The user can then be notified. Freebie packs can be available for specific collections.

In an embodiment, pictures are included in a collection. Pictures can be visible from the very beginning, for example, as a pure design element of the platform. Pictures can also be additional material and/or bonus content to be viewed at a later date. For example, the picture is not displayed until a certain pic set is completed and pasted into a collection.

In an embodiment, the platform is multilingual. The languages can include, but are not limited to, German, English, Spanish, French, Italian, and Russian. In an embodiment, the platform supports transactions in multiple currencies. The platform can support videos, RSS feeds, and links to other programs and/or pages. The pic, pic set, and/or pictures can correlate with one or more videos. The video can be embedded freely or linked to a specified pic and/or pic set. The platform can display text. The text can be displayed with a specified collection. The formatting can be effected by well-known means, for example, HTML and CSS style sheets. For example, all creative possibilities of a normal Rich Text editor can be provided, such as headlines h1-h6, bold italic, underlined, numbering and bullets, and tables. In an embodiment, like image elements, texts can be linked to a pic and/or pic set, and are not displayed until all pics of the corresponding set are pasted. For example, until the entire pic set is acquired, the platform can assign an alternative picture, for example, a placeholder.

In an embodiment, the platform supports users and personalization. The platform can allow for a new user registration requiring a minimum amount of user data, for example, a username and an e-mail address. This can allow a user immediate access to the platform. In an embodiment, additional user information, for example, a password, can be collected at a later time. In an embodiment, the platform allows for a registered user to log in to an existing account. For example, if a login problem arises, the user can choose to have a reactivation link, for example, in the form of a hash code, sent via e-mail or via text to a mobile device. For example, a “forgot password” function allows the user to reset the password. The user can use an e-mail address or other identification means as a login name. If a user has been inactive for a set amount of time, the platform can delete permanently or remove temporarily the inactive user.

In an embodiment, upon access to the platform, if the user is a registered user, the user is navigated to a personalized platform page and their user account can load. If the user is non-registered, the user is navigated to a generic platform homepage. A non-registered user can choose a collection, and begin collecting immediately. A user can be prompted to register, for example, before or after a collection is begun. A user beginning a new collection can receive one or more freebie pics as a welcome bonus. For example, a user beginning a new collection can receive six freebie pics.

In an embodiment, a registered user can administer their account or profile via the platform. The user profile can include additional data fields to be collected at different points in time. In an embodiment, additional data fields include, but are not limited to, last name, first name, e-mail address, user name, a first address line, a second address line, a postal code, city, country, and profile picture. A user can be incentivized to provide additional information, for example, by offering freebie pics, as described above. For example, if a user includes a full name, the user can gain access to two freebie pics. If a user includes a profile picture, the user can gain access to freebie pics, for example, four freebie pics. This could be any number of freebie pics depending upon the situation, for example, predetermined number, dynamic number, random number of pics as desired by the system. The additional data fields can be public or private. In an embodiment, the additional data field privacy settings are selectable by the user, so the user controls what information is visible to other users. In an embodiment, the registered user controls the visibility of his or her own profile and data. The user can control privacy settings in profile administration. In an embodiment, the platform can require certain fields to be public. Personal data includes, but is not limited to, individual information, account data, and optionally billing address(es) and means of payment. In an embodiment, a user does not have to use a full name to register an account.

In an embodiment, a user can view their collection(s) on a personalized platform page and select collection. A collection can be archived. In an embodiment, archiving a collection does not delete a collection, but can remain available in the user's archive for later use.

In an embodiment, a user has a “shop window” visible to him- or herself and all exchange partners. A user's trade proposals and trade requests (discussed below) can be displayed in his or her shop window. The number of proposals and requests visible at any one time can be limited. For example, a maximum of five proposals and requests may be visible. The visible proposals and requests may be for example, selected by the user, chronological, or random. In an embodiment, proposals and requests are collection specific. In an embodiment, the shop window is collection-specific.

In an embodiment, a user has an “inbox,” which can be displayed on the personalized platform page. FIG. 4 shows an embodiment of a normal view of an inbox of a user. In embodiments, the inbox is an area where the user can organize pics that have not yet been assigned to a collection. For example, pics that have not yet been assigned to a collection are not yet pasted, but available for viewing in area 420. Pasting a pic into a collection can move a pic from a user's inbox into a specified collection. The inbox can be assigned to a specific collection, for example, every collection has a separate inbox for each user. In an embodiment, pics of one collection are located in a particular inbox. For example, newest pics 416a and 416b can be listed on the top. In an embodiment, the pics available for pasting in area 420 can be displayed in a matrix, for example 2×6 have one or more scrollbars (not shown) to shown pics that are not currently in view. Another area 412 separated from the area 420, for example, by a divider 414 can display information about the user's collections, packs, and other content such as advertisements and pictures. In an embodiment, the divider 414 is also a menu bar with links that the user can select to navigate to shop window, an activity summary, exchange partners, and exchange notices.

In an embodiment, the user can modify the order using a drag & drop feature. The user can also modify the order by selecting “arrange according to date” and “arrange according to number, or the like.” If an inbox is empty, for example, does not have any unpasted pics, the user can receive information on how to receive new pics. For example, a user can “invite a friend and receive new pics” and “buy new pics in the 2STIC shop.” In an embodiment, where there are more pics in the inbox than can be displayed, a scroll bar will be displayed. In an embodiment, pics are displayed in the inbox according to their respective identification numbers, for example in ascending order.

In an embodiment, the user inbox can be displayed in “compact” view. In an embodiment, the user inbox contains a link that is selectable by the user to activate a function displaying a “normal view” of any collection. In an embodiment, a user inbox can be displayed in “normal” view. A normal view can be displayed as an overlay across the page, for the purpose of manipulation within the inbox and the depot.

In an embodiment, a landing page is presented for each collection. For example a landing page is a first viewable page before entering the collection files. For example, a “normal” view of the inbox is shown on the landing page. In an embodiment, when a user enters the collection, a user can browse through the inbox. For example, the user can browse through the inbox in a “compact” view, e.g., a carousel at the bottom of the display screen, In an embodiment, upon entry in the landing page or as a present feature, a user can determine the desired language for the landing page.

FIG. 5 shows an embodiment of a compact view of the inbox. Compact view displays as a bar 505 at the lower margin of the screen, for the purpose of pasting. The bar 505 may also be located in another portion of the screen (not shown). The pics 510a, b . . . n can be displayed single-spaced and with a horizontal scroll function only. The user can change from normal to compact view, and vice-versa. The order of the pics 510a, b . . . n in normal mode can stay the same in compact view. To paste a pic into a collection page, the user can scroll within a collection to the indicated empty spot. Using the drag & drop feature, the user can drag a pic 510a from the inbox bar along the bottom of the screen to the indicated area 520a, b . . . n, indicated by arrow 515 and drop it over the indicated area 520a. The pic is “pasted” into the user's collection. The pasted pic is displayed with 100% color depth. Before pasting, the pic may appear to be faded or not of 100% color depth. In an embodiment, the user can select a pic (for example, by double-clicking) and the pic will be automatically transported to the corresponding collection page, where the user can then paste the pic. In an embodiment, pasting of the pic is not automatic.

In an embodiment, the depot is a separate area in which a user can store their pics from the inbox. The user can remove pics from the inbox that are not required immediately and keep them in the depot for use, for example, trading, at a later date. For example, pics can also be moved from the depot to the inbox with a mouse click. The depot is a holding place for pics that are not needed, for example, duplicate pics. It can provide a more streamlined inbox by not displaying pics that are not immediately useful. Further functionality can be identical to the inbox.

In an embodiment, a user's current balance is displayed in every collection. The balance can represent the number of packs the user purchased for a specified collection, but has not yet opened.

In embodiments, two or more users can be considered “friends” on the platform, for example, if at least one user has requested to be “friends” with another user, and the recipient of the “friend request” has accepted. A user can have multiple friends. A user can administer their friends in a separate area. A user can receive notifications about their friends' activities on his or her personalized platform page.

In an embodiment, a user can invite a non-registered user to the platform. A user can receive incentives and/or rewards for inviting a friend that subsequently becomes a user. For example, “Bring a Friend” can allow a registered user to invite a friend. If the friend becomes a new (registered) user on the platform, a purchase by the new user provides a percentage of the purchase in freebie pic(s) to the registered user. The registered user can also receive a set number of freebie pics for inviting a friend that becomes a registered user.

In an embodiment, a user can select one or more exchange partners with whom to trade pics. FIG. 6 shows an embodiment of a method for adding an exchange partner by a user. In step 615, if a user reaches a predefined maximum number of exchange partners, the platform will restrict the user from sending an invitation. The platform will notify the user that the user has reached the maximum number of exchange partners for that collection as in step 620. The number of exchange partners per collection can be limited to a specified number, for example, seven. Or, for example, the number of exchange partners can be unlimited per collection. In step 605, a user invites a friend or other user to become exchange partners for a specified collection. In step 610, the other user is notified of an invitation on the platform, and can also receive a notification through a means separate from the platform, for example, an e-mail notification. The user can view all sent and received invitations, as well as their status, on the platform. If a user declines an invitation, the inviting user receives a notification in step 630. The notification can suggest searching for alternative exchange partners. In step 625, the other user decides if she or he wants to become an exchange partner with the user. If a user accepts an invitation, the inviting user can receive a notification. In step 635, the inviting user and the invited user become exchange partners for the specified collection. If the inviting user and the invited user were not previously friends, they will become friends automatically once becoming exchange partners. In an embodiment, exchange partners cannot be removed and/or changed. In an embodiment, exchange partners can be removed or changed.

In an embodiment, the platform sends a user a reminder notification when the user has reached a number near the predefined maximum number of exchange partners. For example, where the maximum number of exchange partners is seven, the user can be warned when the user has added a sixth exchange partner.

In an embodiment, exchange partners are added and accepted as an exchange partner by a user within a collection. Exchange partners always apply to one collection only. In some embodiments, pics are traded only once within a collection and between previously added exchange partners. For example, a maximum of seven exchange partners per collection can be chosen. In some embodiments, exchange partners cannot be removed.

In an embodiment, a user can view a stream of their friends and exchange partners' activities. The stream can be displayed on the user's homepage on the platform. The stream can be displayed chronologically. The stream can also include general information, for example, upcoming marketing events. The stream can include pending requests and proposals from their exchange partners. For example, the proposed and/or requested pic can be displayed; the identification number of the pic can also be displayed. A user's actions and/or activities can be logged on to the platform and displayed in the stream. Such user actions and activities can include progress towards and/or completion of a collection. For example, if the user has completed a collection, and/or if the user has reached a milestone in the collection. Notifications based on specific events can be prominently displayed in the user interface of the platform. Notifications can also be sent from one user to another.

In an embodiment, a user can search for other users and potential exchange partners on the platform on the basis of, for example, friends, exchange partners, family members, and other users with shared interests. The platform can have a central search function. In an embodiment, the central search function can be implemented with an autosuggestion feature. The autosuggestion feature can propose friends from at least one of the following sources: users with whom the user has previously traded pics, users from the user's contacts (for example imported OUTLOOK contacts), and friends on other social media platforms. The central search function can also provide search results. In an embodiment, a user can allow a data field in his or her user profile to be visible or “public”, and the search index will include the user's information. In some embodiments, if a user does not allow a data field in their user profile to be visible or “public”, the search index does not include the user's profile.

In an embodiment, a user adds pics to a specified collection. The pics can be “pasted” and displayed in their designated spot in the collection. The page of the collection can be displayed to paste a pic. In embodiments, once pasted, a pic cannot be removed. In an embodiment, a pic can be removed and/or modified, depending upon the status of the user and/or the pic.

In an embodiment, a collection is always visible for a specific user only. In embodiments, a collection is visible only with the pics that have been pasted. By pasting pics, further content in a collection can be activated and/or made visible. For example, certain pasted pics can activate additional video, audio, pictures, and/or text. Potential bonus content can be displayed and/or activated immediately after pasting the pic(s).

In an embodiment, a pic from a user's inbox and/or depot can only be pasted once into a specified collection. In embodiments, a pic from the user's inbox and/or depot can be pasted only into its designated spot. As described above, the layout of the page, including the order of sections and pages, can be predefined by the platform.

FIG. 7 shows an embodiment of a pic exchange between exchange partners by means of a trade proposal. A user, represented as User A, can exchange a pic in a specified collection with another user, represented as User B, who is an exchange partner for the specified collection. In an embodiment, a user can exchange one pic for one pic, exchange one pic for multiple pics, or exchange multiple pics for multiple pics.

In an embodiment, each pic is associated with a rarity level. For example, the rarity level is tracked by the system in a database, the rarity level being a field in the database associated with the pic identification. In an embodiment, in exchanging pics, a user can be required to exchange multiple pics with a relatively lower rarity level for a pic with a higher rarity level.

In an embodiment, to exchange a pic, a trade proposal can be created. The exchange can occur between a first user and a second user who are exchange partners. In step 705, the first user, represented as User A, selects a pic, e.g., pic 1 to trade from their inbox. In an embodiment, the pic cannot be a pic already pasted into the specified collection. In an embodiment, a pic that has already been pasted can subsequently be “unpasted,” for example, by double-clicking or other action. Such other action may be a button, a checkbox, a single-click, a drag-n-drop, and many other options. In an embodiment, a confirmation is displayed to determine and/or receive additional authorization or indication regarding whether the user wishes to unpaste and trade the pic. The user can then be prompted with a message and/or confirmation that the picture has been unpasted and is now available for exchange.

In step 710, the first user creates and sends a trade proposal to the second user of pic 1 to propose a trade. In step 715, the second user can decide if pic 1 is a pic the second user wants and/or needs for their specified collection. A user can accept to trade for a pic already pasted in the user's collection and/or in the user's inbox. A user can accept or decline a trade proposal. If the second user accepts the first user's trade proposal in step 720, the second user selects a pic, e.g., pic 2, to trade for pic 1 from the first user. When the second user selects pic 2, the second user creates and sends a trade proposal to the first user. Alternatively, if the second user declines the first user's proposal, in step 725, the first user receives a notification. The notification can suggest that the user proceed with another trade proposal. In step 730, if the second user sends a trade proposal of pic 2 for pic 1 to the first user, the first user can accept or decline the proposal. In step 735, the first user declines the proposal, and the process begins anew. In step 740, the first user accepts the proposal, and pic 1 is removed from the first user's inbox and added to the second user's inbox. At the same time, pic 2 is removed from the second user's inbox and added to the first user's inbox. Exchange partners can make one or more trades within a specified collection. A user can decline a trade proposal. The proposer of the trade can receive an automatic notification. Exchange partners can receive information on accepted and declined trade proposals in their event log. Exchange partners can receive information on accepted and declined trade proposals via an e-mail notification. If the pic was a duplicate, the number of the duplicate is reduced. If the user has an existing trade proposal concerning the pic that was traded, the trade proposal is deleted and the affected users are notified. In an embodiment, the number of exchange partners for a given collection is predefined and limited by the platform, for example, five exchange partners. In an embodiment, once an exchange partner is defined for a collection, the partner can never be changed or deleted from the collection in which she or he is a partner.

FIG. 8 shows an embodiment of a user sending a request to an exchange partner by means of a trade request. In step 805, a first user, represented as User A, looking for a specific pic 1 creates a request. In step 810, the second user, represented as User B, views the request for pic 1. The user can choose whether a specific user or all exchange partners view the request. Pic 1 is located in the second user's inbox. In step 815, the second user selects a pic 2 to receive in return. Pic 2 is located in the first user's inbox. In embodiments, the second user can only select a pic that first user has not yet pasted into their collection. The second user creates a trade proposal to trade pic 2 for pic 1. The first user is notified of the trade proposal and can accept or decline the trade proposal in step 820. In sending a request for a specified pic, a user is passively searching for a pic, for example, by advertising for it between the exchange partners. In step 835, the first user declines the proposal sent by the second user. In step 830, the first user accepts the trade proposal, and pic 1 is exchanged for pic 2 in each respective inbox of the first user and the second user.

In an embodiment, a user can trade and receive a pic and/or a duplicate pic. In an embodiment, a pic obtained by a trade can still be traded to another user. In an alternate embodiment, a pic obtained by a trade cannot be traded to another user. In an embodiment, a pic may be traded for a limited number of times. The pic can be marked as no longer tradable with an icon. In an embodiment, when a user is pasting pics into their collection, the non-tradable pics are prioritized before other duplicates. In an embodiment, a database is utilized to keep track of the pic and its associated trading status. That is, if the pic can or cannot be traded, or if there is a preset number of times a pic can be traded, those details associated with the pic are listed in a database, for lookup and access permission when a user requests that specific action with a pic.

A user can view the pending proposals within a specified collection that they themselves have created and/or have received from their exchange partners. When the user is in their inbox and/or depot, a proposal can be created immediately. For example, if a user is within their collection, a request can be created by clicking on an empty pic spot. A specified number of proposals and/or requests can be outstanding. If a user reaches the maximum number of proposals and/or requests, the user can replace an existing proposal and/or request. A user can also delete a proposal and/or request if they no longer desire to make a trade. A user can view their exchange partner's shop windows containing their proposals and/or requests within a specified collection. The user can interact with an exchange partner's shop window, acting on proposals and/or requests. A trade proposal can be created directly from the exchange partner's shop window.

FIG. 9 is a flowchart showing an example method 900 for purchasing a pack according to an embodiment of the present invention. For example, a registered or non-registered user can make purchase in step 901. In an embodiment, the purchase is a pack. In another embodiment, the purchase is a subscription, further discussed below. If the user does not have a positive balance or the checkout is not otherwise successful, the purchase is cancelled in step 921 and the user can receive a corresponding error message. If the user wishes to give the purchase as gift to someone else in step 905, the method 900 sends a coupon code to the gift recipient in step 907. In an embodiment, a user can purchase a coupon for use by himself or herself. A coupon can be labeled by a distinct alphanumeric code, for example, 16-digits long, or by a 2-dimensional bar code or other identification means. In embodiments, coupons are redeemable only once and as a whole, for example, the packs contained in a coupon can all be assigned to one specified collection immediately after redemption. The coupon can indicate when and by whom it was created and which user redeemed it. There can be special coupons with specified redemption dates. The coupons can be purchased online and given a freely selectable redemption date. In some embodiments, if a coupon is redeemed, its content (e.g., packs) is not added to the user's account balance until the redemption date is reached or has already expired. By the time of redemption of the coupon, if the redemption date has already expired, the packs can be added to the user's account balance immediately. If a user account is deactivated before a coupon with specified redemption date could be redeemed, the coupon expires.

In an embodiment, a registered or non-registered user can purchase a subscription for pic packs. The purchaser of the subscription can define the number of pic packs the user will receive in his balance in a defined period of time. For example, a user can receive two pic packs per day, five pic packs per week, or twenty pic packs per month. The purchaser of the subscription can control the distribution of the packs or give the subscriber (that is, the person receiving the pic packs) control. For example, if the purchaser of the subscription pays for twenty packs per month and gives the recipient of the subscription control over the distribution of the pic packs, the recipient of the subscription can decide how the twenty packs will be distributed over time.

In step 909, the method 900 determines whether the purchase is a subscription. If it is a subscription, in step 919, the method 900 sends packs to the user periodically as described above. If the purchase is not a subscription, the method 900 proceeds to step 911 in which the user (or gift recipient having redeemed the coupon code) opens the pack. In step 913, at least one pic is displayed from the pack in the user's inbox. The user can then move the pic(s) to his or her depot in step 915 or paste the pic(s) in the collection in step 917.

FIG. 10 shows another embodiment of a pic exchange method 1000 for making an exchange. In an embodiment, the pic exchange method 1000 operates on mobile platforms. The pic exchange method 1000 is used in situations in which two users are in geographic proximity (for example standing next to each other) such that they can make an offline agreement. In an embodiment, a user has as many eligible exchange partners as she or he prefers and the platform does not set a limit. A user can exchange a pic on a mobile platform. A user can view a list of eligible exchange partners in step 1001. The platform determines whether a user is an eligible exchange partner based on geographic proximity. In an embodiment, this determination is made using at least one of: a geolocation method such as GPS and detection of whether the users are logged into the same WLAN or access point. A user can choose an exchange partner from the list in step 1003, and the platform can dispatch an invitation for the exchange partner to enter into negotiations to make a trade. If the exchange partner accepts the invitation in step 1005, the method 1000 can display a trading graphical user interface (GUI) on the respective user terminals of the user and the selected exchange partner in step 1007. In step 1009, the suser and selected exchange partner interact offline with the aide of the trading GUI to display potential Pics. For example, the user and exchange partner can show each other pics that have not yet been pasted into a collection, duplicate pics, and/or pics that are still needed to complete a collection. In one embodiment, the user interface will display two empty slots where the pics to be exchanged appears for confirmation (such GUI 330 of FIG. 3B). While the pics to be traded are being selected, the screen may look like the compact view in which the user can browse through his or her pics and/or missing pics. The user and the exchange partner can agree offline which pics to trade in step 1011. The user and exchange partner can then drag the pic she or he wishes to trade into the corresponding empty box in the trading GUI and confirm the trade (such as GUI 350 of FIG. 3C) in step 1013. The trade is then made on the mobile platform. The traded pics can be seen in the respective user inbox in step 1015. In an embodiment, the traded pic does not directly paste into a collection, and can be pasted by the user himself at a later time. For example, a traded and/or obtained pic moves into an inbox of the user, and can then be pasted by the user into the electronic album. In an embodiment, the traded pic is directly pasted and/or automatically pasted into a collection.

FIGS. 3A to 3C show example GUIs for a making and completing an exchange according to an embodiment of the present invention. In GUI 310, a user can view a list of eligible exchange partners by selecting link 311. The GUI 310 has an area where tradeable pics 317 can be displayed. Additional pics can be viewed by selecting a scroll bar represented by the right arrow. Scrolling in any direction is possible. In one embodiment, the GUI 310 displays two empty slots 313 and 315 where the pics to be exchanged appears for confirmation. Once an exchange partner is selected, this information can be displayed in an area 331 of a GUI 330. To make an exchange, the user and exchange partner can show each other pics that have not yet been pasted into a collection, duplicate pics, and/or pics that are still needed to complete a collection. When a trade is ready to be made, the pics to be traded can be dragged empty slots 313 and 315 in a GUI 350. Information can be displayed in area 351 as well as directly below the pics. The users can confirm or reject the trade using links 353 and 355. After confirmation, the trade is then made.

In embodiments, a user can access additional material on a mobile platform. For example, a pic linking to additional material can be indicated on the pic. A user can click on the pic to start a video clip, play an audio file, and/or display bonus content. A user can also view additional material in a menu of a specified collection. A user can click on a particular selection, e.g., video clip, to view the material. If a user has not yet activated a particular selection, it can be grayed out until a later time. A user can view what additional information is required to access the particular selection.

In embodiments, a user can purchase a pack of pics for their collection on the platform. To purchase a pack, the user can select the pack for the specified collection. The platform sends the user to a checkout page. A user can purchase a pack as a registered user or as a non-registered user. In an embodiment, a non-registered user can register and accept the platform's terms and conditions prior to purchase. In an embodiment, when a non-registered user purchases a pack, the non-registered user can receive a “coupon” with a code to redeem the pack. For example, the coupon can be sent to a registered user as a gift via e-mail, text message (SMS), or inbox. The registered user can enter the coupon code and immediately redeem the pack. The coupons can also be pre-purchased, for redemption at a specified later date.

In embodiments, a user has the option to purchase packs via the 2STIC shop. The packs purchased can be displayed in the user's balance. User can later open the packs to view the pics and paste the pics. In an embodiment, a non-registered user cannot purchase packs. Registration can be mandatory by the previously non-registered user before and/or at the time of purchase. In an embodiment, a non-registered user can purchase packs. For example, the non-registered user is assigned an identification based on an identifying feature of the non-registered user, such as a device id, an email address, a credit card or purchase card number (e.g., gift card).

In embodiments, if the user purchased packs at the 2STIC online shop, for example, their packs balance is positive, and they can open one or several packs. In doing so, the content of the packs can be added to the user's inbox and the balance is reduced according to the number of opened packs. In embodiments, during the process of opening the packs there can be a blind layer with a progress index to load the pics. The pics can be added to the background. In embodiments, the new pics are added to the inbox and the layer with the progress index vanishes. New pics can always be added at the top of the page. For example, if any older pics are in the inbox they are moved down and/or out of sight. In embodiments, pics that the user receives via a trade with an exchange partner are placed at the top of the inbox. A trade can be automatically accepted in a user's absence, for example, when a user is not actively logged into the platform.

In embodiments, a user with a collection that is partially complete or has reached a “selectable” level of completeness can have the option to purchase the individual pics required to complete the collection. For example, a user having a collection 90% complete can select a “Complete Your Collection” pack that is generated for the user. The “Complete Your Collection” pack can contain the missing pics for the user's specified collection.

In an embodiment, a user viewing a specified collection can purchase packs directly from the collection. A quick checkout can allow the user to select how many packs to purchase and complete the purchase. The packs purchased are added to the user's balance and can be opened and pasted right away.

In an embodiment, a platform provides an online pic collection comprising: a database, a server application, a web interface, and a mobile interface. The platform can be used at least on a computer-based system such as a tablet or a smartphone. The web interface (also referred to as a “website”) can be accessible by users, for example, through a web browser. The web interface can also be accessed by mobile terminals (also referred to as “mobile devices”). The mobile interface can improve the user experience of mobile terminals accessing the platform. The mobile interface can be adapted for mobile operating systems such as iOS and Android.

The website is where a user interacts with the platform. Web browser access for the end user can be directly through a reseller's or licensor's homepage, such that the user is redirected from the reseller's page to his or her collection page. For example, a user with a collection for Borussia Dortmund can be connected to the platform directly from the Borussia Dortmund webpage. Web browser access for the end user can also be directly through the platform's portal, domain name, and website address. The supported web browsers can include, but are not limited to, INTERNET EXPLORER, FIREFOX, and CHROME. The user can access the platform using the Internet and typing the platform address into the address bar of their browser or using a search engine. Any user activity on the platform can be logged in the background, and used, for example, if there are security concerns or for market analysis. For example, a cookie can be saved on the user's system to allow the platform to save personalized information such as language and country.

The mobile interface can be substantially the same as the web interface. Pasting and trading pics can be possible from a smartphone view. Occasionally special adjustments can be made to the specific nature of the mobile interface, for example, such as sizing adjustments. For example, the smartphone view can adjust the viewing size of the collection. The smartphone view can also display rich content including visual or creative aspects. These aspects may include a richer graphic depiction of the collection, and/or viewing bonus content such as video and audio inside the collection. A user in rich content view, the platform can automatically transfer to smartphone view to paste and trade pics. The mobile interface can be stored in a separate module, for example, to increase scalability. The mobile interface can be stored in the same module as the web interface. The data format used for communication with the mobile terminals can be JAVASCRIPT Object Notation (JSON). The mobile operating systems can include, but are not limited to, iOS and Android through the use of a native app.

In embodiments, a user can submit a payment using the platform (through either the mobile interface or the web interface). The payment can be made using a credit card and a debit card. The payment method can also be through a third party payment service provider such as PAYPAL or other services. Pics and/or packs can also be purchased from other sources, including, but not limited to, APPLE ITUNES Store and GOOGLE PLAY Store. A user can save previous payment methods in their account. A user can store credit card information to expedite future purchases. In an embodiment, a user has the option to define a preferred payment method which is suggested to the user at purchase time. In an embodiment, the system keeps track of the last used payment method by the user and suggests that payment method to the user at the time of checkout

In an embodiment, if a user moves the cursor across a pic, a menu with the following options is shown, including, but not limited to: create pic proposal; move pic to depot. In another embodiment, the user can control all aspects of the order and sorting of pics within the inbox within predefined limits. For example, the user can move a pic to a top portion of the inbox; and move a pic to the bottom portion of the inbox. The user is able to move from the inbox to the depot via a button. Pics can be moved to the depot via mouse click. The number of movements from inbox to depot and vice versa is not limited.

The infrastructure for the platform comprises at least: a database server, an application server, a web server, and a content delivery network that can interface with the Internet. The database server can be a MYSQL 5.1 Cluster Edition. Separate servers can be employed. All databases and applications can be regularly backed-up to prevent data loss. The application server can be a ZEND application server version 5.6. Additional application servers can be included to accommodate increased traffic to the platform as necessary. More than one application server can form an application server cluster. For example, the ZEND Server Cluster Manager can be used to configure and manage the cluster. Conversion can be carried out via WORDPRESS, BUDDYPRESS, or PHP. The web server can be an APACHE HTTP server 2.2, or NGINX web server. The web server can handle all static requests. Dynamic requests can be routed to the application server. The servers described above can be virtual servers of a cloud service provider or physical servers.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine read able (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the present invention has been described with reference to particular examples and embodiments, it is understood that the present invention is not limited to those examples and embodiments. The present invention includes variations from the specific examples and embodiments described herein. Except to the extent necessary or inherent in the processes themselves, no particular order to steps or stages of methods or processes described in this disclosure, including the figures is implied. In many cases, the order of process steps may be varied without changing the purpose, effect or import of the methods described.

The subject matter defined in the appended claims is not necessarily limited to the specific features, or specific implementations described above. Many other configurations of computing devices, communications features, applications, and distributed software and/or hardware systems can be employed to implement the described invention as claimed. The specific features and methods described above are thus disclosed as example forms of implementing the claims and embodiments, and can be used in combination with and without each other.

What is claimed is:

1. A method for collecting one or more digital images by a first user, the method comprising:
the first user receiving the one or more digital images; and
locating the one or more digital images in an inbox of the first user;
wherein the one or more digital images are connected to a common theme.

2. The method of claim 1, wherein the receiving of the one or more digital images is purchasing a group of one or more digital images.

3. The method of claim 1, wherein the receiving of the one or more digital images is receiving a free digital image.

4. The method of claim 1, wherein the one or more digital images is one or more pics.

5. The method of claim 2, wherein the group of the one or more digital images is a pack.

6. The method of claim 2, wherein the pack is distributed in subgroups over a predefined time period.

7. The method of claim 3, wherein the free digital image is a freebie pic.

8. The method of claim of claim 1, further comprising pasting a digital image from the one or more digital images into a collection.

9. The method of claim 1, further comprising selecting a digital image from the one or more digital images to create and send a trade proposal to send a trade proposal to a second user.

10. The method of claim 9, further comprising accepting by the second user the trade proposal of the first user, wherein the second user selects an other digital image from an inbox of the second user to create and send a further trade proposal to the first user.

11. The method of claim 10, further comprising exchanging the digital image from the one or more digital images, comprising:
moving the digital image from the inbox of the first user to an inbox of a second user; and
moving the other digital image from the inbox of the second user to the inbox of the first user.

12. A method for collecting and exchanging a digital image between a first user and a second user, the method comprising:
the first user receiving the digital image;
locating the digital image in an inbox of the first user;
selecting the digital image by the first user to create and send a trade proposal to the second user;
the second user accepting the trade proposal of the first user, wherein the second user selects an other digital image to create and send a further trade proposal; and
the first user accepting the further trade proposal to trade the digital image for the other digital image;
wherein the digital image is exchanged for the other digital image in the inbox of the first user.

13. The method of claim 1, wherein the digital image is at least one of: animated and a video.

14. The method of claim 1, wherein the one or more digital images are collected in a collection, wherein the collection is further subdivided into pages.

15. The method of claim 4 wherein the one or more pics are grouped together in a pic set for a particular purpose.

16. The method of claim 15, wherein the one or more pics are optically arranged in the pic set.

17. The method of claim 15, wherein the pic set unlocks a new feature.

18. The method of claim 17, wherein the feature is an achievement, the achievement being displayed to the first user by at least one of: text, picture, and addition of at least one point to a point balance associated with the first user.

19. A method for collecting and exchanging a digital image between a first user and a second user, the method comprising:
the first user requesting the digital image;
locating the digital image in an inbox of the second user;
creating and sending a trade request to the second user;
the second user accepting the trade request of the first user, wherein the second user selects an other digital image to create and send a trade proposal to the first user; and
the first user accepting the trade proposal to trade the other digital image for the digital image;
wherein the other digital image is exchanged for the digital image in the inbox of the second user.

20. A method for acquiring an exchange partner by a first user, comprising:
determining that the first user has not reached a selectable maximum number of exchange partners;
responsive to the determination, the first user inviting a second user to become the exchange partner of the first user;
the second user accepting the exchange partner request;
enabling trading between the first user and the second user.

21. A method for collecting and exchanging a digital image between a first user and an exchange partner, the method comprising:
displaying a list of exchange partners who are in geographic proximity to the first user;
the first user selecting an exchange partner for trading;
the exchange partner accepting the request for trading;
the first user selecting the digital image from an inbox of the first user;
the exchange partner selecting an other digital image from an inbox of the exchange partner; and
creating and sending a trade proposal with the digital image and the other digital image to the first user and the exchange partner;
the first user accepting the trade proposal to trade the digital image for the other digital image; and
the exchange partner accepting the trade proposal to trade the digital image for the other digital image;
wherein the digital image is exchanged for the other digital image in the inbox of the first user.
